(19) United States
(12) Patent Application Publication
(10) Pub. No.: US 2025/0216723 A1
(43) Pub. Date: Jul. 3, 2025

(54) LIQUID CRYSTAL DISPLAY DEVICE

(71) Applicant: SHANGHAI TIANMA MICRO-ELECTRONICS CO., LTD., Shanghai (CN)

(72) Inventor: Katsuhiro ITO, Kawasaki (JP)

(21) Appl. No.: 18/965,194

(22) Filed: Dec. 2, 2024

(30) Foreign Application Priority Data
Dec. 28, 2023 (JP) 2023-222251

(51) Int. Cl. G02F 1/1335

(52) U.S. Cl. CPC G02F 1/133624; G02F 1/133504; G02F 1/133526

(57) ABSTRACT

A liquid crystal display device includes a liquid crystal display panel including a display region, a backlight unit located behind the liquid crystal panel and including layered optical sheets, a light source of non-visible light disposed inside or behind the backlight unit, a diffusion structural unit located in front of the light source and configured to diffuse non-visible light from the light source, and a lens unit configured to condense light that is diffused by the diffusion structural unit, hits an object and is reflected off the object onto a sensor. The optical sheets include a diffusion sheet. The diffusion structural unit is smaller in size than the display region and selectively disposed at a location to be irradiated with non-visible light from the light source. At least one of the optical sheets is interposed between the diffusion structural unit and the light source.

### CROSS-REFERENCE TO RELATED APPLICATIONS

This non-provisional application claims priority under 35 U.S.C. § 119 (a) on Patent Application No. 2023-222251 filed in Japan on Dec. 28, 2023, the entire content of which is hereby incorporated by reference.

### BACKGROUND

This disclosure relates to a liquid crystal display device.

Liquid crystal display devices have a wide field of application from small mobile phones to large television monitors because of their characteristics of low power consumption and availability of high resolution. The liquid crystal display device can be equipped with a camera device including a light source and a sensor for recognizing an object in order to recognize a fingerprint or a gesture.

An example of a tool for recognizing a gesture is an NIR-TOF camera unit including a vertical cavity surface emitting laser (VCSEL) that emits near infrared (NIR) light, a time of flight (ToF) image sensor, and a lens unit.

The NIR-ToF camera unit calculates the distance to an object based on the time taken for the NIR light emitted from the VCSEL to return to the ToF image sensor through the lens unit after hitting and being reflected off the object. To use the NIR-ToF camera unit on a liquid crystal panel, the NIR-ToF camera unit is usually disposed behind the cover panel. The region where the NIR-ToF camera is disposed becomes a non-display region.

### SUMMARY

A liquid crystal display device according to an aspect of this disclosure includes a liquid crystal panel including a display region on which images are displayed toward a viewer located in front of the liquid crystal display device; a backlight unit located behind the liquid crystal panel, the backlight unit including a plurality of layered optical sheets; a light source of non-visible light disposed inside or behind the backlight unit; a diffusion structural unit located in front of the light source, the diffusion structural unit being configured to diffuse non-visible light from the light source; and a lens unit configured to condense light that is diffused by the diffusion structural unit, hits an object and is reflected off the object onto a sensor. The plurality of optical sheets include a diffusion sheet configured to diffuse visible light. The diffusion structural unit is smaller in size than the display region and selectively disposed at a location to be irradiated with non-visible light from the light source. At least one of the plurality of optical sheets is interposed between the diffusion structural unit and the light source.

It is to be understood that both the foregoing general description and the following detailed description are exemplary and explanatory and are not restrictive of this disclosure.

### BRIEF DESCRIPTION OF THE DRAWINGS

FIG. 1 schematically illustrates a liquid crystal display device in an embodiment.

FIG. 2 is a plan diagram schematically illustrating a configuration example of a camera unit.

FIG. 3 schematically illustrates a cross-sectional structure of a part of a liquid crystal display device in an embodiment of this disclosure.

FIG. 4 is a diagram illustrating the positional relation between a light source unit and a lens unit.

FIG. 5 schematically illustrates a cross-sectional structure of a part of a liquid crystal display device in another embodiment of this disclosure.

FIG. 6 schematically illustrates a cross-sectional structure of a part of a liquid crystal display device in still another embodiment of this disclosure.

FIG. 7 schematically illustrates a cross-sectional structure of a part of a liquid crystal display device in still another embodiment of this disclosure.

FIG. 8 schematically illustrates a cross-sectional structure of a part of a liquid crystal display device in still another embodiment of this disclosure.

FIG. 9 schematically illustrates a cross-sectional structure of a part of a liquid crystal display device in still another embodiment of this disclosure.

FIG. 10 provides examples of intensity profiles of the light diffused by different diffusion sheets.

### EMBODIMENTS

Hereinafter, embodiments of this disclosure will be described with reference to the accompanying drawings. It should be noted that the embodiments are merely examples to implement this disclosure and not to limit the technical scope of this disclosure.

This disclosure relates to a camera unit including a light source unit and a light reception unit. An example of the camera unit is an NIR-ToF camera unit. The light from its light source unit is near infrared (NIR) light and its light reception unit is a time-of-flight (ToF) camera.

For an NIR-ToF camera unit to reduce the light emitted from the light source unit but blocked by the light reception unit, it is important to provide a large distance between the light reception unit and the light source unit. Especially in the case of a type having a wide angle of view, a larger distance is necessary; downsizing the NIR-ToF camera unit is difficult. To mount the NIR-ToF camera behind the liquid crystal panel, holes have to be opened through the liquid crystal panel for both of the lens unit and the VCSEL; those regions become non-display regions that cannot show any image.

An embodiment of this disclosure disposes a diffusion structural unit (also simply referred to as diffusion structure) of the light source unit at a location upper than and distant from the emission surface of the light source. As a result, the distance between the light source unit and the light reception unit can be reduced to allow downsizing the camera unit. In the following, the embodiments of this disclosure are described more specifically.

### Embodiment 1

### Configuration of Liquid Crystal Display Device

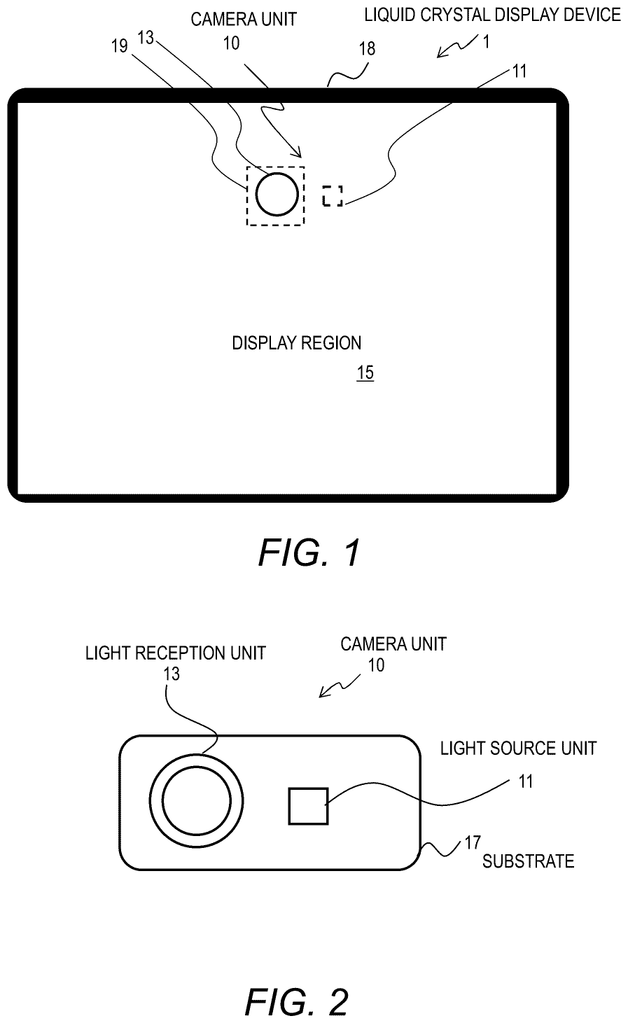

FIG. 1 schematically illustrates a liquid crystal display device in this embodiment. The liquid crystal display device 1 displays images on a display region 15 of a liquid crystal panel toward the viewer. The periphery of the display region 15 is a bezel region 18 of a non-display region. The liquid crystal display device 1 includes a not-shown backlight unit and a camera unit 10 disposed behind the liquid crystal panel.

FIG. 2 is a plan diagram schematically illustrating a configuration example of the camera unit 10. The camera unit 10 includes a light source unit 11, a light reception unit 13, and a substrate 17. The light source unit 11 and the light reception unit 13 are disposed on the substrate 17. The substrate 17 can be replaced with two substrates and the light source unit 11 and the light reception unit 13 can be mounted on different substrates.

The light source unit 11 emits light toward an object located on the front side where the viewer is located. The light reception unit 13 receives light emitted by the light source unit 11 and reflected off the object. The camera unit 10 can be an NIR-TOF camera unit. The light from the light source unit 11 is near infrared (NIR) light. The wavelength of the NIR light is in the range from 750 nm to 1000 nm. The light reception unit 13 is a ToF camera.

The control circuit on the substrate 17 measures the information corresponding to the time taken for the NIR light emitted from the light source unit 11 to return to the light reception unit 13 after being reflected off the object. The information enables calculation of the distance from the camera unit 10 to the object and detection of the three-dimensional shape of the object. The features of this disclosure are applicable to camera units different from NIR-ToF camera units that use invisible light having a wavelength different from the NIR light or employ a different measurement scheme.

Returning to FIG. 1, the camera unit 10 includes a light source unit 11 and a light reception unit 13 as described above. The light reception unit 13 of the camera unit 10 is placed in a hole 19 provided in the display region 15; the region of the hole 19 is a non-display region. The light source unit 11 is disposed in the display region 15. The entire circumference of the hole 19 is surrounded by the display region 15.

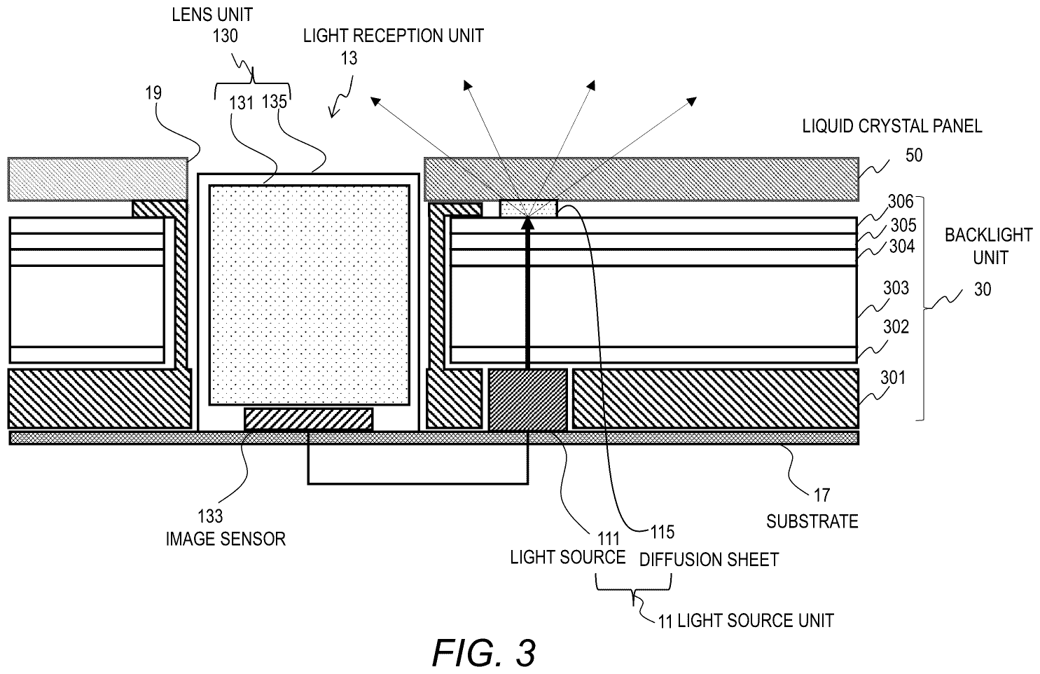

FIG. 3 schematically illustrates a cross-sectional structure of a part of a liquid crystal display device 1 in an embodiment of this disclosure. In FIG. 3, the upper side corresponds to the front side of the liquid crystal display device 1 where the viewer or the object is located. The liquid crystal display device 1 includes a liquid crystal panel 50 and a backlight unit 30 disposed behind the liquid crystal panel 50. The liquid crystal display device 1 further includes a light reception unit 13 and a light source unit 11. As described with reference to FIG. 2, the light reception unit 13 and the light source unit 11 are included in a camera unit 10.

The liquid crystal panel 50 can be of any type such as twisted nematic (TN) type or in-plane switching (IPS) type. An example of the liquid crystal panel 50 includes a TFT substrate and an opposite substrate opposed to the TFT substrate. A liquid crystal layer is sandwiched between the TFT substrate and the opposite substrate. The TFT substrate includes an insulating substrate transparent to visible light. The insulating substrate can have a rectangular shape and one of the main faces is opposed to one main face of the opposite substrate. A polarizing plate is attached on the other main face of the insulating substrate that is not facing the liquid crystal layer.

In the case of an IPS liquid crystal panel, pixel electrodes and common electrodes for applying electric fields to the liquid crystal layer are arrayed on the TFT substrate. One pair of a pixel electrode and a common electrode applies an electric field to one pixel. The pixel changes the amount of light to be transmitted therethrough depending on the applied electric field. The TFT substrate includes a thin-film transistor (TFT) array for selecting a pixel to be controlled.

In the case of a TN liquid crystal panel, pixel electrodes for applying electric fields to the liquid crystal layer are arrayed on the TFT substrate and a common electrode is disposed on the opposite substrate. An electric field is applied to the liquid crystal of one pixel between a pixel electrode and the common electrode. The amount of light to be transmitted through the pixel changes depending on the applied electric field. The TFT substrate includes a thin-film transistor (TFT) array for selecting a pixel to be controlled.

In the case of a full-color liquid crystal panel, the opposite substrate includes a color filter. The opposite substrate includes an insulating substrate made of glass or resin. The insulating substrate can have a rectangular shape. A polarizing plate is attached on the main face of the insulating substrate that is not facing the liquid crystal layer.

Either the TFT substrate or the opposite substrate is located on the side closer to the viewer or the front and the other one is on the rear side or back side. That is to say, the backlight unit 30 is disposed behind the TFT substrate or the opposite substrate of the liquid crystal panel.

The backlight unit 30 illuminates the liquid crystal panel 50 from behind of it. The liquid crystal panel 50 displays an image based on a driving signal input thereto. The viewer views the displayed image that is generated by the light emitted from the backlight unit 30 and transmitted through the liquid crystal panel 50.

The backlight unit 30 includes a plurality of layered optical sheets in a chassis 301. For example, the plurality of optical sheets include a reflective sheet 302, a light guide plate 303, a diffusion sheet 304, a condenser sheet 305, and a two-dimensional condenser sheet 306 in this order from the lower side of FIG. 3 or the side farther from the liquid crystal panel 50. Each optical sheet includes a function unit that controls (diffuses or condenses) visible light.

The reflective sheet 302, the light guide plate 303, the diffusion sheet 304, the condenser sheet 305, and the two-dimensional condenser sheet 306 can be larger in size than the display region 15 of the liquid crystal panel. The reflective sheet 302, the light guide plate 303, the diffusion sheet 304, the condenser sheet 305, and the two-dimensional condenser sheet 306 are also called optical sheets 302 to 306. When viewed in the layering direction of the backlight unit 30 and the liquid crystal panel 50, the entire display region 15 overlaps the optical sheets and can be located inner than the outer ends of the optical sheets. One or more of the optical sheets can be smaller than the display region 15.

The chassis 301 can have a shape like a box with its top face opened. The optical sheets 302 to 306 are laid one above another on the bottom of the chassis 301. The chassis 301 for containing the optical sheet 302 to 306 can be made of metal or resin.

Each optical sheet can be made of resin and can have any thickness. For example, the reflective sheet 302 can be a polyolefin-based white reflective plate that effectively reflects visible light. The light guide plate 303 is an optical sheet for obtaining uniform planar visible light and can be made of polycarbonate or polystyrene. Commonly, the light guide plate 303 is thicker than the other optical plates and the thickness can be several millimeters, specifically, within a range from 5 mm to 8 mm. The other optical sheets can have a thickness of several ten to several hundred micrometers, specifically, within a range from 20 μm to 500 μm.

The diffusion sheet 304 can have a structure such that acrylic beads are bonded to a polyethylene terephthalate substrate. The condenser sheets 305 and 306 have arrayed prisms on their surfaces to increase the frontal luminance of the liquid crystal display device. Polyester or polycarbonate can be used for the condenser sheets 305 and 306.

The kinds and the number of optical sheets included in the backlight unit 30 can be determined desirably and are not limited to the configuration of this disclosure. Although FIG. 3 illustrates a configuration example of an edge type backlight unit, a direct backlight unit including light sources arrayed in the plane of the liquid crystal panel 50 can be employed. When viewed from the backlight unit 30, the liquid crystal panel 50 is located in front or on the light-emitting side.

As described with reference to FIG. 1, the light reception unit 13 is placed in the hole 19 provided in the liquid crystal panel 50 and the backlight unit 30. The light reception unit 13 includes an image sensor 133 mounted on the substrate 17 disposed behind the backlight unit 30.

The image sensor 133 can be a ToF image sensor. The ToF image sensor measures the distances between the ToF image sensor and points on an object by measuring the times taken for the light emitted from the light source unit 11 to return to the image sensor after being reflected off the points on the object. The kind of the image sensor 133 is not limited to a specific one; instead of the image sensor, one-dimensional sensor can be employed.

The light reception unit 13 further includes a lens unit 130. The lens unit 130 includes stacked lenses 131 placed in front of the image sensor 133 and a lens barrel 135 for firmly supporting the stacked lenses 131. The stacked lenses 131 include a plurality of lenses disposed from the back side (the side closer to the image sensor 133) toward the front. Each lens is fixed to the lens barrel 135.

In the example of FIG. 3, the image sensor 133 located under the stacked lenses 131 is placed in the lens barrel 135. The stacked lenses 131 condense the NIR light reflected off the object onto the image sensor 133. As described above, the lens unit 130 is placed in the hole in the liquid crystal panel 50 and the backlight unit 30 and neither the liquid crystal panel 50 nor the backlight unit 30 exist in front of the lens unit 130. The lens unit 130 is surrounded by the side walls of the chassis 301 of the backlight unit 30. The side walls of the chassis 301 surrounding the lens unit 130 are optional.

The light source unit 11 includes a light source 111 and a diffusion sheet 115. The diffusion sheet 115 is an example of a diffusion structural unit. An example of the light source 111 is a vertical cavity surface emitting laser (VCSEL). The VCSEL is a semiconductor laser that emits a laser beam perpendicularly from the top face (the opposite face from the substrate 17). The structure of the light source 111 is not limited as long as the light source 111 can emit a predetermined intensity of light in a predetermined radiation angle toward the front.

The light source 111 is disposed at a place distant from the light reception unit 13 on the substrate 17 that is disposed behind the backlight unit 30. The light source 111 is disposed behind the optical sheets 302 to 306 of the backlight unit 30. Specifically, the light source 111 is disposed behind the lowermost reflective sheet 302.

In the configuration example of FIG. 3, the light source 111 is placed in a hole provided in the chassis 301. This configuration enables the light from the light source 111 to enter the optical sheets without being blocked by the chassis 301.

There is no component between the light source 111 and the reflective sheet 302; the NIR light from the light source 111 directly enters the reflective sheet 302. At least a part of the NIR light passes through the optical sheets 302 to 306 of the backlight unit 30 and enters the diffusion sheet 115 of the light source unit 11. Some part of the NIR light can be absorbed, reflected, or diffused by the optical sheets in the backlight unit 30. In the configuration example of FIG. 3, the space between the light source 111 and the diffusion sheet 115 includes parts of all optical sheets 302 to 306 but does not include any other component.

The diffusion sheet 115 of the light source unit 11 is disposed to be included in the emission surface (the top face in FIG. 3) of the light source 111 when viewed in the direction of layering the optical sheets 302 to 306 or the vertical direction in FIG. 3. The NIR light from the light source 111 linearly passes through the optical sheets 302 to 306 and enters the diffusion sheet 115. The diffusion sheet 115 is smaller in size than the display region 15 and disposed selectively at the location to be irradiated with the NIR light from the light source 111.

In the configuration example of FIG. 3, the diffusion sheet 115 is disposed between the condenser sheet 306 and the liquid crystal panel 50. The condenser sheet 306 is the uppermost optical sheet in the backlight unit 30. The diffusion sheet 115 can be bonded to the surface of the condenser sheet 306 with an adhesive. The adhesive can have a refractive index closer to the refractive indices of the diffusion sheet 115 and the condenser sheet 306 and at a value between them. The diffusion sheet 115 can be in contact with the back face of the liquid crystal panel 50.

In the configuration example of FIG. 3, a part or the entirety of the diffusion sheet 115 overlaps the display region 15 of the liquid crystal panel 50. This configuration allows expansion of the display region 15. Disposing the diffusion sheet 115 behind the liquid crystal panel 50 achieves smaller effect onto the display in the display region 15. The entirety of the diffusion sheet 115 can be located outside the display region 15.

The diffusion sheet 115 is smaller in area than the optical sheets 302 to 306 of the backlight unit 30 but its area is large enough to receive the light from the light source 111. The diffusion sheet 115 receives the light in the range including at least the half-value width from the center of light from the light source 111. The diffusion sheet 115 having a minimum area reduces the interference with the display of the liquid crystal panel 50.

The diffusion sheet 115 employs a material and a structure that can effectively diffuse NIR light. The diffusion sheet 115 can be made of resin or glass and has a diffusing structure for diffusing NIR light, such as a structure of a scattering plate or a grating. The diffusion sheet 115 enables NIR light to diffuse more evenly. It is preferable that the NIR light diffused by the diffusion sheet 115 have an intensity profile such that an object located within the angle of view of the light reception unit 13 can be evenly irradiated.

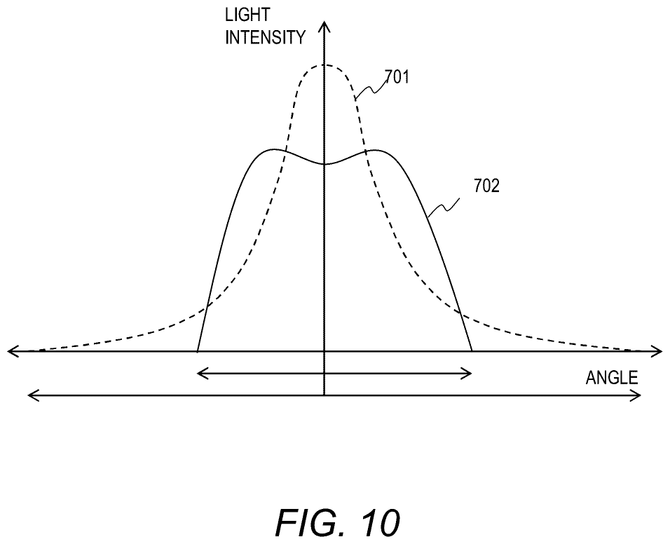

FIG. 10 provides examples of intensity profiles of the light diffused by diffusion sheets 115. FIG. 10 includes a normal distribution 701 of the intensity of light diffused by a standard diffusion sheet 115 and an intensity profile 702 of the light diffused by a preferable diffusion sheet 115. The vertical axis represents the intensity of the diffused NIR light. The horizontal axis represents the angle with respect to the optical axis of the incident light. Compared to the normal distribution 701 in which the intensity of NIR light diffused by the diffusion sheet decreases with the angle with respect to its optical axis, the rectangular intensity profile 702 is preferable, in which the intensity of NIR light diffused by the diffusion sheet is almost flat within a specific angle.

The diffusion sheet 115 is allowed to diffuse NIR light to a wider angle than the optical sheets 302 to 306 of the backlight unit 30 including the diffusion sheet 304. The diffusion sheet 115 is designed to diffuse the light from the light source 111 to a desired angle. The diffusion angle of the diffusion sheet 115 for visible light can be narrower than its diffusion angle for NIR light. This configuration achieves smaller effect onto the display of the liquid crystal panel 50. The diffusion angle of any of the diffusion sheets of the backlight unit 30 for visible light can be wider than that for NIR light.

There exist optical sheets of the backlight unit 30 between the diffusion sheet 115 of the light source unit 11 and the emission surface (top face) of the light source 111; the diffusion sheet 115 is disposed distant from the light source 111. This configuration brings the diffusion point of NIR light closer to the viewer and allows the distance between the light source unit 11 and the light reception unit 13 to be reduced. In the configuration example in FIG. 3, the diffusion sheet 115 is disposed at a location more distant from the viewer than the top face (the face closest to the viewer) of the stacked lenses 131, or at a location closer to the substrate 17.

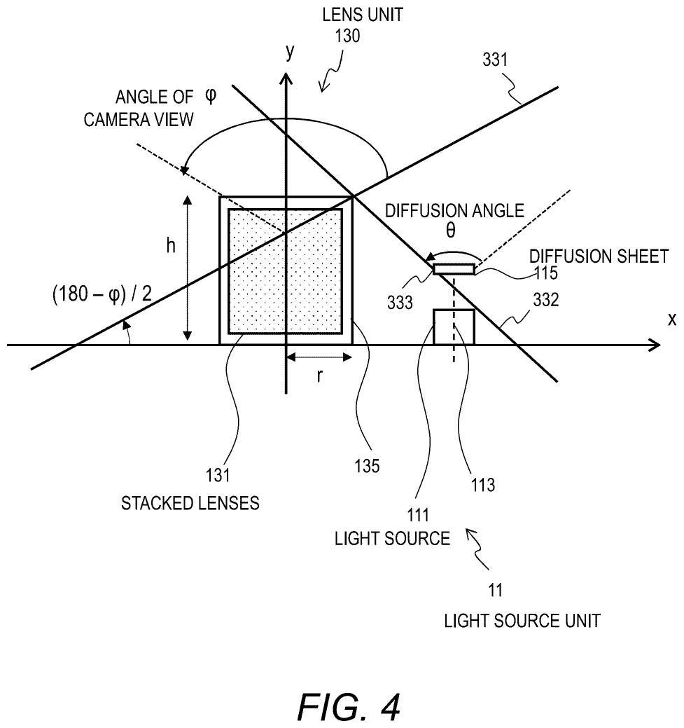

Hereinafter, the positional relation between the diffusion sheet 115 of the light source unit 11 and the lens unit 130 is described. FIG. 4 is a diagram illustrating the positional relation between the light source unit 11 and the lens unit 130. FIG. 4 includes the light source 111, the diffusion sheet 115, the stacked lenses 131, and the lens barrel 135. The axis connecting the intersection between the undersurface of the lens unit 130 and the central axis of the stacked lenses 131 and the intersection between the undersurface of the light source 111 and the optical axis 113 of the light source 111 is defined as x-axis. The central axis of the stacked lenses 131 is defined as y-axis.

The light source 111 and the diffusion sheet 115 are disposed so that the light diffused by the diffusion sheet 115 will not be blocked by the lens unit 130. As illustrated in FIG. 4, the light emitted from the light source 111 and diffused by the diffusion sheet 115 has a diffusion angle of θ. The lens unit 130 has an angle of camera view of ϕ. The lens unit 130 has a height of h and an outer diameter of 2r. Although the lens unit 130 in this example has a columnar shape, the lens unit can have a different shape. In that case, the distance (shortest distance) between the central axis of the stacked lenses 131 and the point closest to the diffusion sheet 115 in the lens unit 130 can be defined as r.

In FIG. 4, the line 331 that depends on the angle of camera view ϕ can be expressed as the following formula:

$$y = x * tan ( ( 180 - ϕ ) / 2 ) + h - r * tan ( ( 180 - ϕ ) / 2 ) .$$

Further, the line 332 that depends on the diffusion angle θ of the diffusion sheet 115 can be expressed as the following formula:

$$y = - x * 1 / tan ( θ / 2 ) + r / tan ( θ / 2 ) + h .$$

The diffusion sheet 115 can be disposed so that its point 333 (x, y) closest to the lens unit 130 will be located in the region satisfying the following condition. If the point 333 of the diffusion sheet 115 is located in the region satisfying the following condition, the diffused NIR light will not be blocked by the lens unit 130 and efficient use of the NIR light is available:

$$- x * 1 / tan ( θ / 2 ) + r / tan ( θ / 2 ) + h \leq y \leq x * tan ( ( 180 - ϕ ) / 2 ) + h - r * tan ( ( 180 - ϕ ) / 2 ) .$$

As described above, disposing the diffusion sheet of the light source unit outside the angle of view of the lens unit and disposing the lens unit outside the diffusion range of the NIR light that is determined by the diffusion angle θ of the diffusion sheet effectively prevent the light from the light source from being blocked by the lens unit.

### Other Embodiments

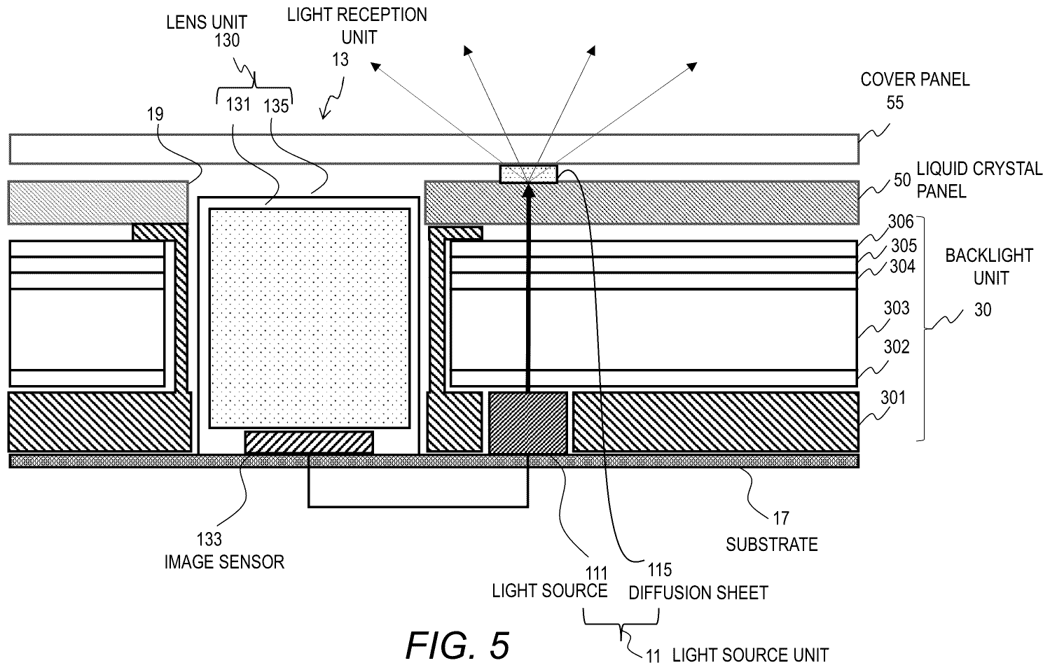

FIG. 5 schematically illustrates a cross-sectional structure of a part of a liquid crystal display device 1 in another embodiment of this disclosure. The following mainly describes differences from the configuration example in FIG. 3. Unless otherwise specified, the description provided with reference to FIG. 3 is applicable.

In the configuration example in FIG. 5, the diffusion sheet 115 of the light source unit is disposed between the liquid crystal panel 50 and a cover panel 55. The cover panel 55 is disposed on the front of the liquid crystal panel 50 and it is a component made of glass or resin. The cover panel 55 transmits visible light and NIR light. Disposing the diffusion sheet 115 on the front of the liquid crystal panel 50 enables disposing the light source unit 11 closer to the light reception unit 13. The cover panel 55 prevents the diffusion sheet 115 and the liquid crystal panel 50 from damage, although the cover panel 55 is optional.

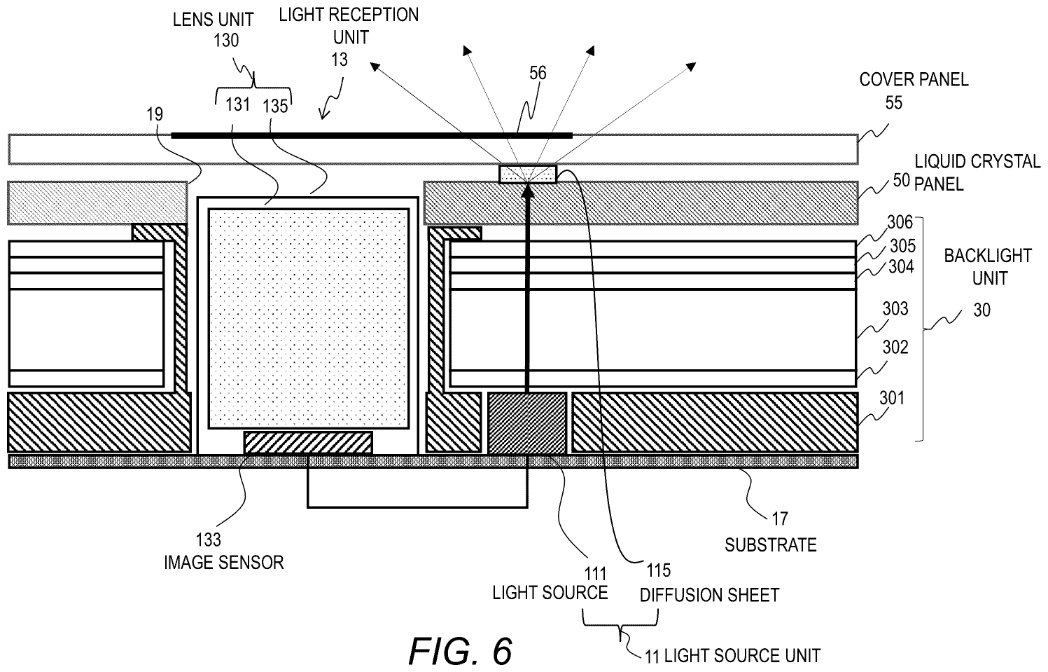

FIG. 6 schematically illustrates a cross-sectional structure of a part of a liquid crystal display device 1 in still another embodiment of this disclosure. Compared to the configuration example in FIG. 5, the configuration example in FIG. 6 further includes a near infrared transmission filter (IR filter) 56. The IR filter 56 is disposed on the front of the cover panel 55; it transmits NIR light and absorbs visible light. The IR filter 56 covers the entire light reception unit 13 and light source unit 11 when viewed from the viewer. The IR filter 56 prevents the viewer from viewing odd display caused by the light reception unit 13, the light source unit 11, and/or the diffusion sheet 115. The configuration example in FIG. 3 can also include the IR filter on the front of the liquid crystal panel 50.

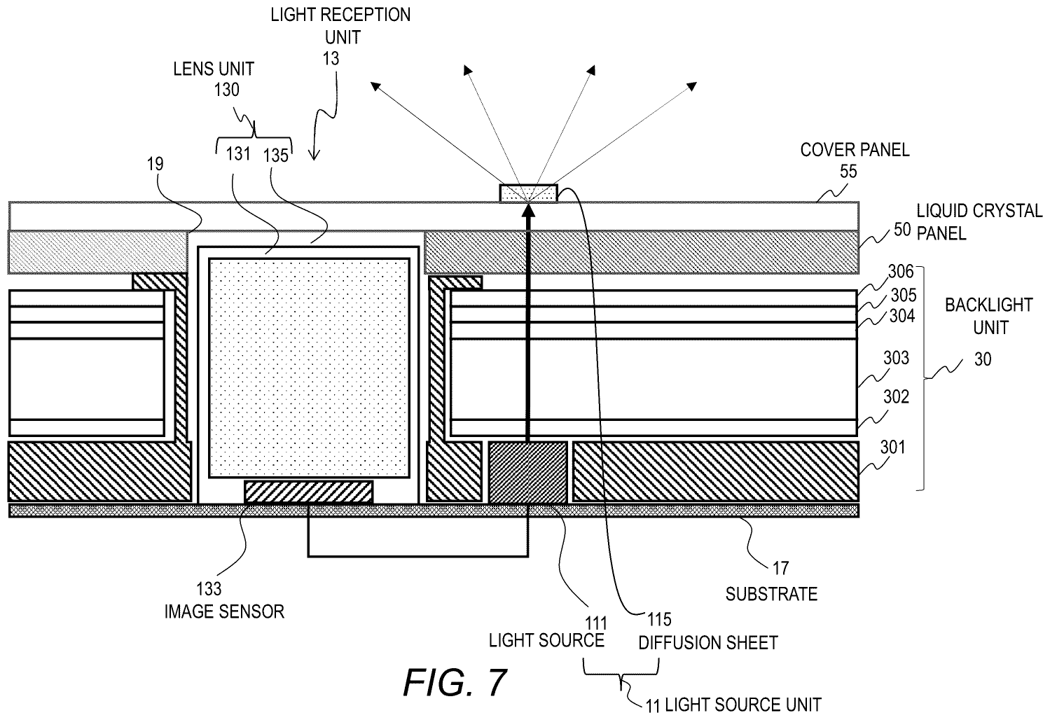

FIG. 7 schematically illustrates a cross-sectional structure of a part of a liquid crystal display device 1 in still another embodiment of this disclosure. Compared to the configuration example in FIG. 5, the configuration example in FIG. 7 includes a diffusion sheet 115 disposed on the front of the cover panel 55. The remaining is the same as the configuration in FIG. 5. The diffusion sheet 115 is disposed on the outermost surface of the liquid crystal display device 1. Increasing the distance between the diffusion sheet 115 and the light source 111 allows more reduction of the distance between the light reception unit 13 and the light source unit 11. The diffusion sheet 115 disposed on the front of the cover panel 55 reduces the reflection of NIR light off the back face of the cover panel 55.

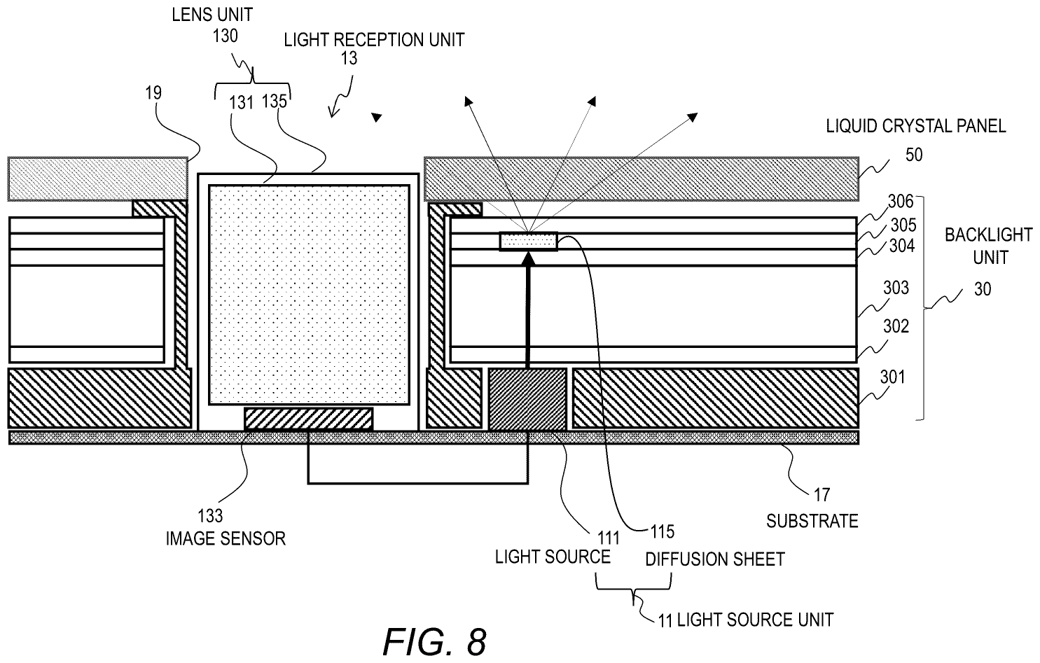

FIG. 8 schematically illustrates a cross-sectional structure of a part of a liquid crystal display device 1 in still another embodiment of this disclosure. The following mainly describes differences from the configuration example in FIG. 3. Unless otherwise specified, the description provided with reference to FIG. 3 is applicable. Compared to the configuration example in FIG. 3, the configuration example in FIG. 8 includes a diffusion sheet 115 disposed in the optical sheets 302 to 306 of the backlight unit 30.

For example, the diffusion sheet 115 can be disposed in a hole provided in one or more optical sheets of the backlight unit 30. The diffusion sheet 115 can be interposed between adjacent optical sheets of the backlight unit 30 and overlap with all optical sheets 302 to 306 when viewed in the layering direction.

The diffusion sheet 115 in the configuration example in FIG. 8 is disposed in a hole provided in the condenser sheet 305 and sandwiched between the condenser sheet 306 and the diffusion sheet 304. The diffusion sheet 115 can be sandwiched between other optical sheets, for example, between the light guide plate 303 and the diffusion sheet 304 or between the light guide plate 303 and the condenser sheet 305. These configurations can achieve small effect on the display on the liquid crystal panel 50 while increasing the distance between the light source 111 and the diffusion sheet 115.

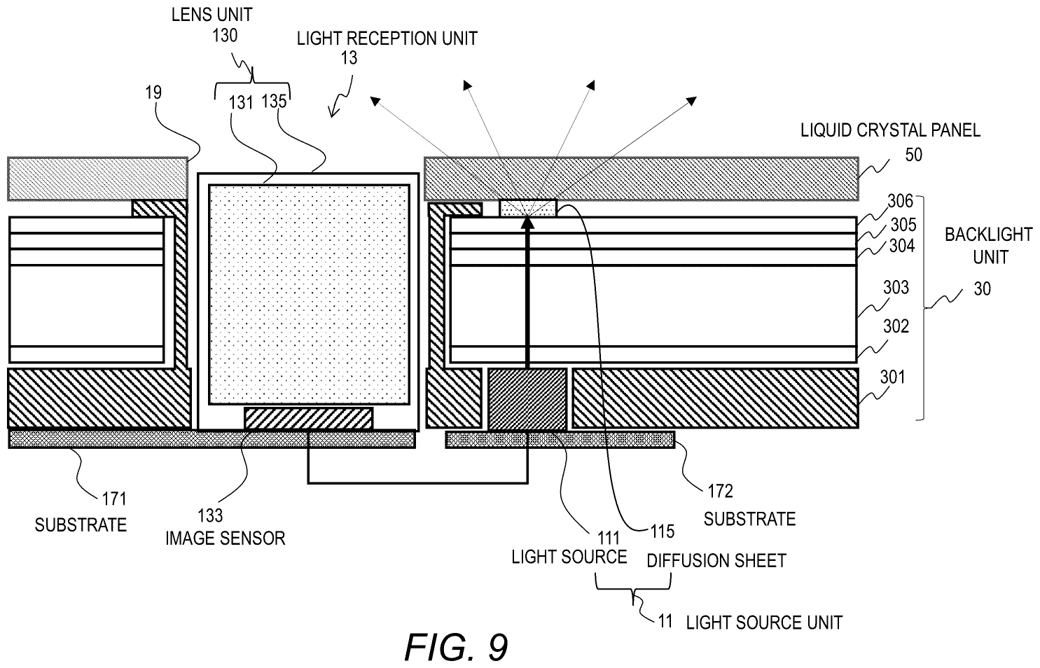

FIG. 9 schematically illustrates a cross-sectional structure of a part of a liquid crystal display device 1 in still another embodiment of this disclosure. The following mainly describes differences from the configuration example in FIG. 3. In the configuration example in FIG. 9, the substrate 17 shown in FIG. 3 is separated into two substrates 171 and 172. The light reception unit 13 is disposed on the substrate 171 and the light source 111 is disposed on the substrate 172. This configuration increases the flexibility in disposition of the light source unit 11 and the light reception unit 13 and facilitates assembling the components. This separate substrate configuration is applicable to the configuration examples in FIGS. 5 to 8.

Each of the light source and the diffusion structural unit included in the light source unit 11 can be configured variously. For example, the NIR light diffusion structural unit can be not only the above-described diffusion sheet 115 that can be disposed at various locations and can have various shapes but also a component in common with another function unit. For example, the diffusion structural unit can be provided in the insulating substrate of the liquid crystal panel 50 or the cover panel 55. In another example, the diffusion structural unit can be provided in another function unit in the optical sheets included in the backlight unit 30, for example, in a region not for the function units for condensing and diffusing visible light.

In the foregoing configuration examples illustrated in the drawings, the liquid crystal panel 50 has a hole in front of the light reception unit 13 and the light reception unit 13 is exposed from the liquid crystal panel 50. In another configuration example, the liquid crystal panel 50 does not have a hole for the light reception unit 13 and covers the light reception unit 13. In other words, the entire light reception unit 13 can overlap the liquid crystal panel 50 in the layering direction. For example, the configuration example in FIG. 5 or 6 does not have a hole for the light reception unit 13 in the liquid crystal panel 50 and the light reception unit 13 is covered with not only the cover panel 55 but also the liquid crystal panel 50.

As set forth above, embodiments of this disclosure have been described; however, this disclosure is not limited to the foregoing embodiments. Those skilled in the art can easily modify, add, or convert each element in the foregoing embodiments within the scope of this disclosure. A part of the configuration of one embodiment can be replaced with a configuration of another embodiment or a configuration of an embodiment can be incorporated into a configuration of another embodiment.

What is claimed is:

1. A liquid crystal display device comprising:
a liquid crystal panel including a display region on which images are displayed toward a viewer located in front of the liquid crystal display device;
a backlight unit located behind the liquid crystal panel, the backlight unit including a plurality of layered optical sheets;
a light source of non-visible light disposed inside or behind the backlight unit;
a diffusion structural unit located in front of the light source, the diffusion structural unit being configured to diffuse non-visible light from the light source; and
a lens unit configured to condense light that is diffused by the diffusion structural unit, hits an object and is reflected off the object onto a sensor;
wherein the plurality of optical sheets include a diffusion sheet configured to diffuse visible light,
wherein the diffusion structural unit is smaller in size than the display region and selectively disposed at a location to be irradiated with non-visible light from the light source, and
wherein at least one of the plurality of optical sheets is interposed between the diffusion structural unit and the light source.

2. The liquid crystal display device according to claim 1,
wherein the diffusion structural unit is disposed outside the angle of view of the lens unit, and
wherein the lens unit is disposed outside a range to which the diffusion structural unit diffuses the non-visible light.

3. The liquid crystal display device according to claim 1, wherein a part or the entirety of the diffusion structural unit overlaps the display region of the liquid crystal panel.

4. The liquid crystal display device according to claim 1, wherein the diffusion structural unit is disposed between the liquid crystal panel and the backlight unit.

5. The liquid crystal display device according to claim 1, wherein all the optical sheets of the backlight unit are interposed between the light source and the liquid crystal panel.

6. The liquid crystal display device according to claim 1, further comprising:
a cover panel disposed in front of the liquid crystal panel,
wherein the diffusion structural unit is disposed between the liquid crystal panel and the cover panel.

7. The liquid crystal display device according to claim 1, further comprising:
a cover panel disposed in front of the liquid crystal panel,
wherein the diffusion structural unit is disposed on a front surface of the cover panel.

8. The liquid crystal display device according to claim 1, wherein the lens unit is disposed in a hole provided in the backlight unit.

9. The liquid crystal display device according to claim 1, wherein the lens unit is disposed in a hole provided in the liquid crystal panel and the backlight unit.
